(19) United States
(12) Patent Application Publication
(10) Pub. No.: US 2020/0356511 A1
(43) Pub. Date: Nov. 12, 2020

(54) CONTROL CIRCUIT, COMMUNICATION DEVICE, AND COMMUNICATION SYSTEM

(71) Applicant: Sony Semiconductor Solutions Corporation, Kanagawa (JP)

(72) Inventor: Akito Sekiya, Kanagawa (JP)

(21) Appl. No.: 16/962,778

(22) PCT Filed: Jan. 9, 2019
(86) PCT No.: PCT/JP2019/000279

§ 371 Date: Jul. 16, 2020

(30) Foreign Application Priority Data
Jan. 23, 2018 (JP) 2018-008803

(51) Int. Cl. G06F 13/40; G06F 13/42; H02J 7/34

(52) U.S. Cl. CPC G06F 13/4022; G06F 2213/0016; H02J 7/345; G06F 13/4282

(57) ABSTRACT

The present technology relates to a control circuit, a communication device, and a communication system that enable cost reduction.

A switch switches on or off connection between a pulled-up bus and a power storage unit. The pulled-up bus is a bus that is pulled up in a plurality of buses that are connected to a communication device and include at least one bus that is pulled up. The power storage unit stores electric power supplied from the pulled-up bus, and supplies the stored electric power as a power supply to the communication device. A control unit performs control to turn on or off the switch. The present technology can be applied to a communication system that performs I2C communication, for example.

### TECHNICAL FIELD

The present technology relates to a control circuit, a communication device, and a communication system, and more particularly, to a control circuit, a communication device, and a communication system that enable cost reduction.

### BACKGROUND ART

For example, Inter-Integrated Circuit (I2C) is known as one of the communication methods for serial communication (see Non-Patent Document 1, for example).

### CITATION LIST

### Non-Patent Document

Non-Patent Document 1: NXP Semiconductors, “UM10204 I2C-bus specification and user manual”, Rev. 6-4, April 2014

### SUMMARY OF THE INVENTION

### Problems to be Solved by the Invention

A communication system that performs I2C communication compliant with I2C includes a first communication device as a device called a master, and one or more second communication devices as devices called slaves, and the first communication device and the second communication devices are connected to an I2C bus. The I2C bus includes a serial clock line (SCL) that is a bus (a signal line) for transmitting a clock signal for conducting synchronization between the master and the slaves, and a serial data line (SDA) that is a bus (a signal line) for conducting data transmission and reception between the master and the slaves.

The I2C devices (the master and the slaves) that perform I2C communication need at least four wiring lines: the two buses (the SCL and the SDA) constituting the I2C bus, a power line that is the wiring line connected to the power source (voltage drain: VDD) for supplying a power supply to the I2C devices, and a GND line that is the wiring line connected to the ground (GND).

In a case where a plurality of I2C devices constituting a communication system is disposed on the same printed circuit board, for example, VDD and GND are arranged (shared) as a surface on the printed circuit board. Accordingly, only the I2C bus, which is the two buses of the SCL and the SDA, is required between the master and each slave.

However, in a case where a plurality of I2C devices constituting a communication system is not disposed on the same printed circuit board, but is disposed at physically separated places, each of the master and slave I2C devices needs wiring lines such as the power line and the GND line, as well as the two buses of the SCL and the SDA. Therefore, the number of wiring lines becomes larger than that in a case where the master and the slaves are disposed on the same printed circuit board. As a result, the costs of the wiring lines become higher.

The present technology has been made in view of such circumstances, and is to enable cost reduction.

### Solutions to Problems

A control circuit of the present technology is a control circuit that includes: a switch that switches on or off connection between a pulled-up bus and a power storage unit, the pulled-up bus being a bus that is pulled up in a plurality of buses that are connected to a communication device and include at least one bus that is pulled up, the power storage unit storing electric power supplied from the pulled-up bus and supplying the stored electric power as a power supply to the communication device; and a control unit that performs control to turn on or off the switch.

In the control circuit of the present technology, the switch is controlled so that the switch is turned on or off. The switch switches on or off connection between a pulled-up bus and a power storage unit. The pulled-up bus is a bus that is pulled up in a plurality of buses that are connected to a communication device and include at least one bus that is pulled up. The power storage unit stores electric power supplied from the pulled-up bus, and supplies the stored electric power as a power supply to the communication device.

A communication device of the present technology is a communication device that includes: a switch that switches on or off connection between a pulled-up bus and a power storage unit, the pulled-up bus being a bus that is pulled up in a plurality of buses that are connected to the communication device and include at least one bus that is pulled up, the power storage unit storing electric power supplied from the pulled-up bus and supplying the stored electric power as a power supply to the communication device; and a logical unit that performs control to turn on or off the switch.

In the communication device of the present technology, the switch is controlled so that the switch is turned on or off. The switch switches on or off connection between a pulled-up bus and a power storage unit. The pulled-up bus is a bus that is pulled up in a plurality of buses that are connected to a communication device and include at least one bus that is pulled up. The power storage unit stores electric power supplied from the pulled-up bus, and supplies the stored electric power as a power supply to the communication device.

A first communication system of the present technology is a communication system that includes: a first communication device and a second communication device that are connected to a plurality of buses having at least one bus pulled up, and perform communication via the plurality of buses; a power storage unit that stores electric power supplied from a pulled-up bus that is a bus pulled up in the plurality of buses, and supplies the stored electric power as a power supply to the second communication device; and a control circuit that controls connection between the pulled-up bus and the power storage unit. In the first communication system, the control circuit includes: a switch that switches on or off connection between the pulled-up bus and the power storage unit; and a control unit that performs control to turn on or off the switch.

In the first communication system of the present technology, the first communication device and the second communication device are connected to the plurality of buses including at least one bus that is pulled up, and perform communication via the plurality of buses. In the power storage unit, electric power supplied from a pulled-up bus that is a bus pulled up in the plurality of buses is stored, and the stored electric power is supplied as a power supply to the second communication device. The control circuit performs control to turn on or off the switch that switches on or off connection between the pulled-up bus and the power storage unit.

A second communication system of the present technology is a communication system that includes: a first communication device and a second communication device that are connected to a plurality of buses having at least one bus pulled up, and perform communication via the plurality of buses; and a power storage unit that stores electric power supplied from a pulled-up bus that is a bus pulled up in the plurality of buses, and supplies the stored electric power as a power supply to the second communication device. In the second communication system, the second communication device includes: a switch that switches on or off connection between the pulled-up bus and the power storage unit; and a logical unit that performs control to turn on or off the switch.

In the second communication system of the present technology, the first communication device and the second communication device are connected to the plurality of buses including at least one bus that is pulled up, and perform communication via the plurality of buses. In the power storage unit, electric power supplied from a pulled-up bus that is a bus pulled up in the plurality of buses is stored, and the stored electric power is supplied as a power supply to the second communication device. The second communication device performs control to turn on or off the switch that switches on or off connection between the pulled-up bus and the power storage unit.

### Effects of the Invention

According to the present technology, costs can be reduced.

Note that the effects of the present technology are not limited to the effect described herein, and may include any of the effects described in the present disclosure.

### BRIEF DESCRIPTION OF DRAWINGS

FIG. 1 is a block diagram showing an example configuration of a conventional communication system that performs I2C communication.

FIG. 2 is a block diagram showing an example configuration of a first embodiment of a communication system to which the present technology is applied.

FIG. 3 is a waveform diagram for explaining an example of a communication protocol of I2C communication, showing examples of the voltages of an SCL and an SDA.

FIG. 4 is a flowchart for explaining a process to be performed by a control unit 122.

FIG. 5 is a flowchart for explaining an example process to be performed by a communication device 20 to cope with a shortage of the power to be supplied to communication devices 30.

FIG. 6 is a flowchart for explaining an example process to be performed by a control circuit 120 to cope with a shortage of the power to be supplied to the communication devices 30.

FIG. 7 is a block diagram showing an example configuration of a second embodiment of a communication system to which the present technology is applied.

FIG. 8 is a block diagram showing an example configuration of a third embodiment of a communication system to which the present technology is applied.

FIG. 9 is a block diagram showing an example configuration of a fourth embodiment of a communication system to which the present technology is applied.

FIG. 10 is a block diagram showing an example configuration of an embodiment of a computer to which the present technology is applied.

### MODE FOR CARRYING OUT THE INVENTION

<Example Configuration of a Communication System that Performs I2C Communication>

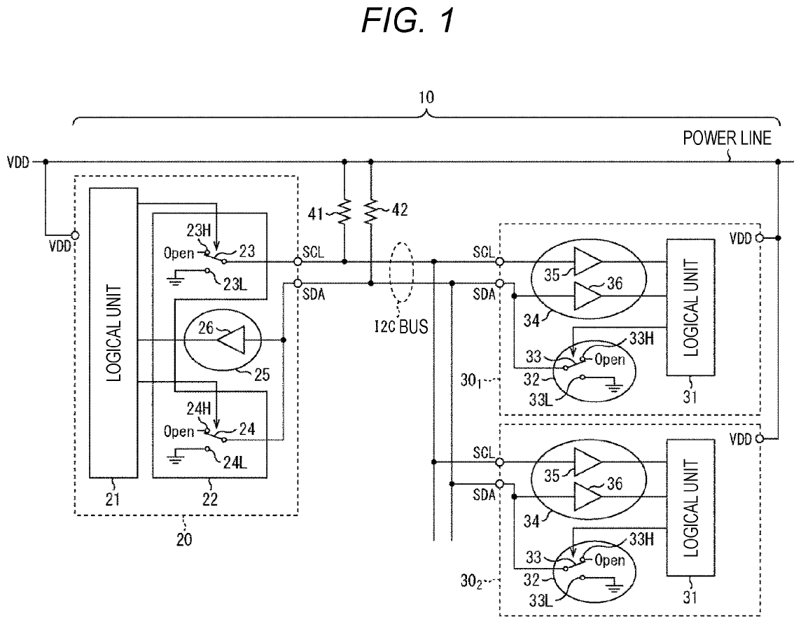

FIG. 1 is a block diagram showing an example configuration of a conventional communication system that performs I2C communication.

In I2C communication, serial communication is performed between a master and a slave with a voltage between each of the two buses of an SCL and an SDA that constitute an I2C bus, and a reference GND. The two buses of the SCL and the SDA, which constitute the I2C bus, are connected to the other end of a resistor having its one end connected to VDD (this resistor will be hereinafter also referred to as the pull-up resistor), so that the two buses are pulled by via the pull-up resistor.

Also, in I2C communication, the master short-circuits the SCL and the SDA to GND, and leave the SCL and the SDA open, to express the low (L) level and the high (H) level on the I2C. The slave operates in accordance with the H level and the L level expressed on the I2C bus.

In FIG. 1, a communication system 10 includes a communication device 20, a communication device 301, and a communication device 302, and the communication device 20, the communication device 301, and the communication device 302 are connected to an I2C bus. The communication device 20, the communication device 301, and the communication device 302 each have an SCL terminal to which the SCL of the I2C bus is connected, and an SDA terminal to which the SDA is connected. The SCL is connected to each SCL, and the SDA is connected to each SDA terminal. Also, the communication device 20, the communication device 301, and the communication device 302 each have a VDD terminal to which VDD is connected, and a power line is connected to the VDD terminal. Further, a GND line that is not shown in the drawing is connected to each of the communication device 20, the communication device 301, and the communication device 302.

Hereinafter, in cases where there is no need to distinguish the communication devices 301 and 302 from each other, the communication devices 301 and 302 will be referred to simply as the communication devices 30.

As for the I2C bus, the SCL is pulled up to VDD via a pull-up resistor 41, and the SDA is pulled up to VDD via a pull-up resistor 42. Accordingly, the SCL and the SDA are pulled-up buses that are pulled up to VDD.

The communication device 20 is a communication device that functions as an I2C master. The communication device 20 includes a logical unit 21, a transmission unit 22, and a reception unit 25. The transmission unit 22 is formed with a switch 23 and a switch 24, and the reception unit 25 is formed with a buffer 26.

The logical unit 21 performs control necessary for causing the communication device 20 to function as an I2C master.

The switch 23 is connected to the SCL terminal, and selects a terminal 23H or a terminal 23L, under the control of the logical unit 21. The terminal 23H is in an open state, and the terminal 23L is in a short-circuited state, being connected to GND. Accordingly, the SCL is switched to the H level in a case where the switch 23 selects the terminal 23H, and the SCL is switched to the L level in a case where the switch 23 selects the terminal 23L.

The switch 24 is connected to the SDA terminal, and selects a terminal 24H or a terminal 24L, under the control of the logical unit 21. The terminal 24H is in an open state, and the terminal 24L is in a short-circuited state, being connected to GND. Accordingly, the SDA is switched to the H level in a case where the switch 24 selects the terminal 24H, and the SDA is switched to the L level in a case where the switch 24 selects the terminal 24L.

The buffer 26 receives a signal on the SDA, and supplies the signal to the logical unit 21.

The communication device 301 is a communication device that functions as an I2C slave. The communication device 301 includes a logical unit 31, a transmission unit 32, and a reception unit 34. The transmission unit 32 is formed with a switch 33, and the reception unit 34 is formed with a buffer 35 and a buffer 36.

The logical unit 31 performs control necessary for causing the communication device 30 to function as an I2C slave.

The switch 33 is connected to the SDA terminal, and selects a terminal 33H or a terminal 33L, under the control of the logical unit 31. The terminal 33H is in an open state, and the terminal 33L is in a short-circuited state, being connected to GND. Accordingly, the SDA is switched to the H level in a case where the switch 33 selects the terminal 33H, and the SDA is switched to the L level in a case where the switch 33 selects the terminal 33L.

The buffer 35 receives a signal on the SCL, and supplies the signal to the logical unit 31.

The buffer 36 receives a signal on the SDA, and supplies the signal to the logical unit 31.

The communication device 302 is a communication device that functions as an I2C slave. The communication device 302 has a configuration similar to that of the communication device 301, and therefore, explanation thereof is not made herein.

Note that, in FIG. 1, the communication system 10 includes the communication device 301 and the communication device 302 as two slaves. However, the number of slaves constituting the communication system 10 is not necessarily two, and may be one, or three or larger. The same applies to the communication systems described later.

In the communication system 10, I2C communication is performed between the communication device 20 as the master and the communication devices 30 as the slaves.

In the I2C communication, the logical unit 21 controls the switches 23 and 24 in the communication device 20 as the master, to cause the voltages of the SCL and the SDA to fluctuate, and transmit data to the communication devices 30 as the slaves. In each communication device 30 as a slave, the buffer 35 and the buffer 36 receive the voltages of the SCL and the SDA, and supply the voltages to the logical unit 31, so that the data transmitted from the communication device 20 as the master is received.

Meanwhile, the logical unit 31 controls the switch 33 in each communication device 30 as a slave, so that the voltage of the SDA is made to fluctuate, and data is transmitted to the communication device 20 as the master. In the communication device 20 as the master, the buffer 26 receives the voltage of the SDA, and supplies the voltage to the logical unit 21, so that the data transmitted from each communication device 30 as a slave is received.

In a case where the communication system 10 configured as described above is applied to a wearable device that performs living body sensing, for example, various kinds of sensors that perform living body sensing are connected to the communication devices 30 as the slaves, and are disposed in respective sites in the body. In this case, the wiring lines between the communication device 20 as the master and the communication devices 30 as the slaves are longer.

Further, the wiring lines connected between the communication device 20 as the master and the communication devices 30 as the slaves are the four lines of an SCL, an SDA, a power line, and a GND line. Because of the large number, the cable combining these four lines becomes heavier and thicker. As a result, the degree of freedom (wearability) of the wearable device becomes lower.

### First Embodiment

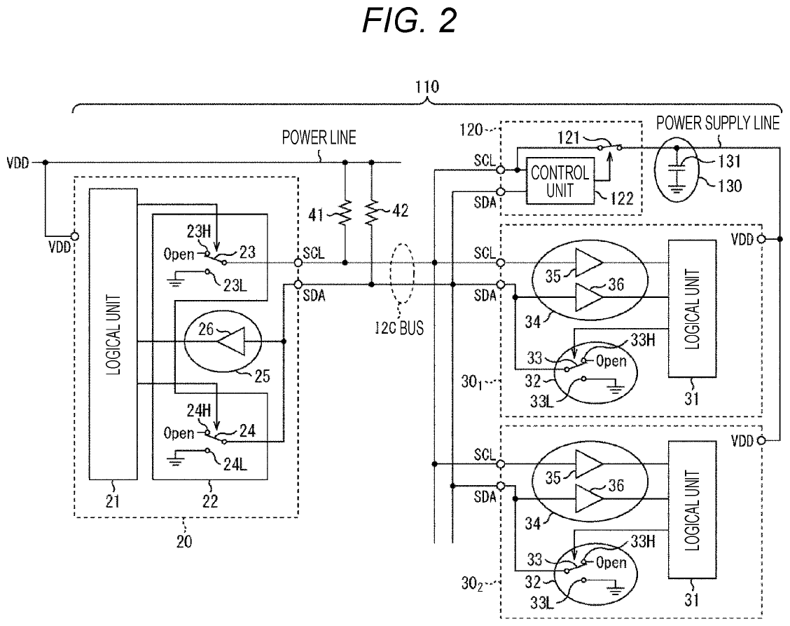

FIG. 2 is a block diagram showing an example configuration of a first embodiment of a communication system to which the present technology is applied.

Note that, in the drawing, the components corresponding to those in FIG. 1 are denoted by the same reference numerals as those used in FIG. 1, and explanation thereof is not repeated herein.

In FIG. 2, a communication system 110 includes a communication device 20, a communication device 301, a communication device 302, a control circuit 120, and a power storage unit 130, and the communication device 20, the communication device 301, the communication device 302, and the control circuit 120 are connected to a pulled-up I2C bus. Meanwhile, the power storage unit 130 is connected to the VDD terminals of the communication device 301 and the communication device 302.

Accordingly, the communication system 110 is the same as the communication system 10 shown in FIG. 1, in including the communication device 20, the communication device 301, and the communication device 302 connected to the pulled-up I2C bus.

However, in including the control circuit 120 and the power storage unit 130 connected to the I2C bus, the communication system 110 differs from the communication system 10 that does not include the control circuit 120 and the power storage unit 130. The communication system 110 also differs from the communication system 10 having the VDD terminal of each communication device 30 connected to VDD, in that the VDD terminal of each communication device 30 is connected to the power storage unit 130.

In the communication system 110 shown in FIG. 2, the SCL, which is one of the two buses (the SCL and the SDA) of the pulled-up I2C bus, is connected to the power storage unit 130 formed with a capacitance or a battery or the like via a switch 121. The power storage unit 130 stores the power supplied from the SCL, and supplies the stored power as a power supply to each communication device 30 as a slave.

The control circuit 120 includes a switch 121 and a control unit 122, and controls connection between the SCL, which is a pulled-up bus, and the power storage unit 130. The control circuit 120 also operates using the power stored in the power storage unit 130 as a power supply, for example.

Under the control of the control unit 122, the switch 121 switches on or off the connection between the SCL pulled up via the pull-up resistor 41 and the power storage unit 130. Note that a normally-on switch can be adopted as the switch 121.

In a case where a normally-on switch is adopted as the switch 121, when sufficient power is not supplied to the control circuit 120, the switch 121 is turned on, so that the power storage unit 130 is connected to the SCL. In this case, the power storage unit 130 can store the power supplied from the pulled-up SCL. The power storage unit 130 then becomes able to supply the stored power as a power supply to each communication device 30 and the control circuit 120.

The control unit 122 performs control to turn on or off the switch 121, depending on the states of the two buses of the SCL and the SDA. For example, when the two buses of the SCL and the SDA enter a state to start communication, the control unit 122 determines that communication between the communication device 20 and each communication device 30 has been started, and performs control to turn off the switch 121. Also, when the two buses of the SCL and the SDA enter a state to end communication, the control unit 122 determines that the communication between the communication device 20 and each communication device 30 has been ended, and performs control to turn on the switch 121.

The power storage unit 130 is formed with a capacitor 131, for example. One end of the capacitor 131 is connected to GND, and the other end is connected to a wiring line that connects the switch 121 and the VDD terminal of each communication device 30 (hereinafter, this wiring line will be also referred to as the power supply line). Accordingly, the other end of the capacitor 131 is also connected to the SCL via the switch 121. The power storage unit 130 stores, in the capacitor 131, the power supplied from the SCL via switch 121. The power storage unit 130 also supplies the power stored in the capacitor 131 as a power supply to each communication device 30 (and the control circuit 120). Each communication device 30 (and the control circuit 120) operates using the power supplied from the power storage unit 130 as a power supply.

In the communication system 110, the SCL and the SDA are pulled up to VDD. Further, in a case where communication (data transmission/reception) is not being performed between the communication device 20 and the communication devices 30, the switch 23 in the communication device 20 selects the terminal 23H, and the switch 24 in the communication device 20 selects the terminal 24H, while the switch 33 in the communication device 30 selects the terminal 33H. Accordingly, in a case where communication is not being performed between the communication device 20 and each communication device 30 (at a time of non-communication), a power supply voltage is constantly applied to the SCL and the SDA. In a case where communication is not being performed between the communication device 20 and each communication device 30 in the communication system 110, the switch 121 is on, so that power is stored into the power storage unit 130 with the power supply voltage being constantly applied to the SCL. That is, the capacitor 131 of the power storage unit 130 is electrically charged until the capacitor 131 reaches the power supply voltage. In the communication system 110, the power (amount) stored in the power storage unit 130 is used as a power supply to each communication device 30 (and the control circuit 120).

Further, in a case where communication is performed between the communication device 20 and each communication device 30 in the communication system 110, the switch 23 may select the terminal 23L, or the switch 24 may select the terminal 24L. In a case where the switch 23 selects the terminal 23L, the SCL is short-circuited, and, if the switch 121 is on, the power stored in the power storage unit 130 is discharged to GND via the switch 121 that is on.

Therefore, the control unit 122 controls the switch 121 so that the switch 121 is turned on and off, depending on the states of the two buses of the SCL and the SDA. By doing so, the control unit 122 prevents discharge of the power stored in the power storage unit 130 in a case where the SCL is short-circuited.

In a case where communication (I2C communication) between the communication device 20 and each communication device 30 is started in the communication system 110, the two buses of the SCL and the SDA enter a state to start communication. As the two buses of the SCL and the SDA enter a state to start communication, the control unit 122 then controls the switch 121 so that the switch 121 is turned off. As the control unit 122 controls the switch 121 so that the switch 121 is turned off, the connection between the power storage unit 130 and the SCL is cut off, and discharge of the power stored in the power storage unit 130 can be prevented.

Further, in a case where communication between the communication device 20 and each communication device 30 is to be ended, the two buses of the SCL and the SDA enter a state to end communication. As the two buses of the SCL and the SDA enter a state to end communication, the control unit 122 then controls the switch 121 so that the switch 121 is turned on. As the control unit 122 controls the switch 121 so that the switch 121 is turned on, the power storage unit 130 and the SCL are connected to each other, and the power storage unit 130 stores power, using the power supplied from the SCL.

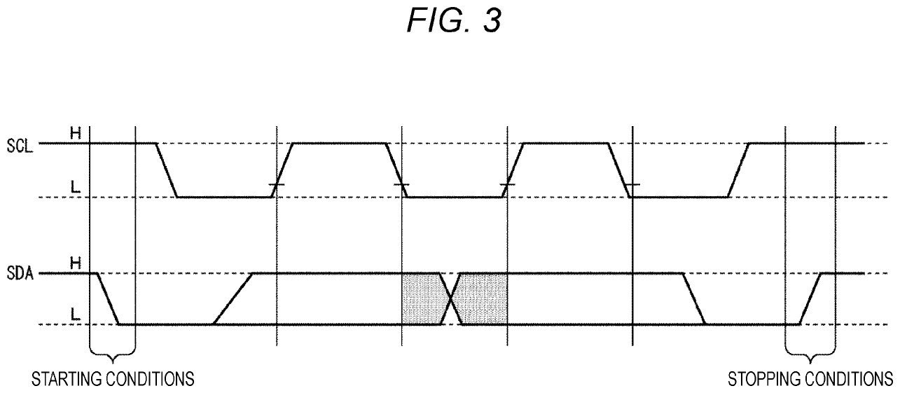

FIG. 3 is a waveform diagram for explaining an example of a communication protocol of I2C communication, showing examples of the voltages of the SCL and the SDA.

Before starting communication (in a non-communicating state), the communication device 20 causes the switch 23 to select the terminal 23H, and causes the switch 24 to select the terminal 24H, so that (the voltages of) the SCL and the SDA are switched to the H level. After that, when starting communication, the communication device 20 causes the switch 24 to select the terminal 24L, to switch the SDA from the H level to the L level. In the I2C bus, the states of the SCL and the SDA at a time when the SDA switches from the H level to the L level while the SCL remains at the H level are called the starting conditions. The communication device 20 declares the start of communication by setting the states of the SCL and the SDA to the starting conditions. After that, communication is performed between the communication device 20 and each communication device 30.

In a case where the control unit 122 detects that the states of the SCL and the SDA have been set to the starting conditions, the control unit 122 controls the switch 121 (FIG. 2) so that the switch 121 is turned off, to cut off the connection between the SCL and the power storage unit 130 (FIG. 2). As a result, in the communication between the communication device 20 and each communication device 30, the SCL is switched to the L level (is put into a short-circuited state), discharge of the power stored in the power storage unit 130 (to GND) is prevented (reduced).

Before ending the communication, the communication device 20 causes the switch 23 to select the terminal 23H, and causes the switch 24 to select the terminal 24L, so that the SCL is switched to the H level, and the SDA is switched to the L level. After that, when ending the communication, the communication device 20 causes the switch 24 to select the terminal 24H, to switch the SDA from the L level to the H level. In the I2C bus, the states of the SCL and the SDA at a time when the SDA switches from the L level to the H level while the SCL remains at the H level are called the stopping conditions. The communication device 20 declares the end of the communication by setting the states of the SCL and the SDA to the stopping conditions. The communication between the communication device 20 and each communication device 30 is then ended.

In a case where the control unit 122 detects that the states of the SCL and the SDA have been set to the stopping conditions, the control unit 122 controls the switch 121 (FIG. 2) so that the switch 121 is turned on, to connect (reconnect) the SCL and the power storage unit 130 (FIG. 2). A power supply voltage is applied to the power storage unit 130 via the SCL, and the power storage unit 130 then starts (restarts) storing power (charging).

Here, in the communication system 110, the power storage unit 130 is connected to the SCL via the switch 121, and stores the power supplied from the SCL. However, the power storage unit 130 can be connected to the SDA, instead of the SCL, and store the power supplied from the SDA. Note that, in a case where the power storage unit 130 is connected to the SDA, in the starting conditions for starting communication between the communication device 20 and each communication device 30, the SDA is at the L level (a short-circuited state). Therefore, when the starting conditions are detected, the SDA is in a short-circuited state, and the power stored in the power storage unit 130 is discharged to GND via the short-circuited SDA. To prevent such discharge, it is desirable that the power storage unit 130 be connected to the SCL that is maintained at the H level in the starting conditions for the I2C bus.

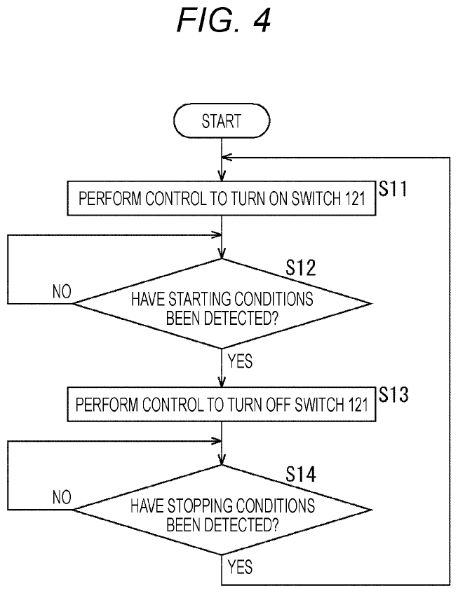

FIG. 4 is a flowchart for explaining a process to be performed by the control unit 122.

In step S11, the control unit 122 performs control so that the switch 121 is turned on (or the normally-on switch 121 is turned on, regardless of the control of the control unit 122), and the process moves on to step S12. As the switch 121 is turned on, the power storage unit 130 is electrically charged with the electric power supplied from the SCL via the switch 121. The electric power stored in the power storage unit 130 is supplied as a power supply to each communication device 30.

In step S12, the control unit 122 determines (detects) whether the states of the two buses of the SCL and the SDA have switched to the starting conditions. In a case where it is determined in step S12 that the states of the SCL and the SDA have not been switched to the starting conditions, the process returns to step S12. In a case where it is determined in step S12 that the states of the SCL and the SDA have switched to the starting conditions, on the other hand, the process moves on to step S13.

In step S13, the control unit 122 performs control so that the switch 121 is turned off, and the process moves on to step S14. As the switch 121 is turned off, the charging of the power storage unit 130 ends (is suspended). Even after the charging of the power storage unit 130 is completed, the power stored in the power storage unit 130 is supplied as a power supply to each communication device 30.

In step S14, the control unit 122 determines (detects) whether the states of the two buses of the SCL and the SDA have switched to the stopping conditions. In a case where it is determined in step S14 that the states of the SCL and the SDA have not switched to the stopping conditions, the process returns to step S14. In a case where it is determined in step S14 that the states of the SCL and the SDA have switched to the stopping conditions, on the other hand, the process returns to step S11, and the control unit 122 performs control so that the switch 121 is turned on, as described above.

After that, processes similar to the above are repeated, so that control is performed to turn on or off the switch 121, depending on the states of the two buses of the SCL and the SDA.

As described above, in the communication system 110, the control unit 122 performs control to turn on or off the switch 121, depending on the states of the two buses of the SCL and the SDA, and controls the connection between the SCL and the power storage unit 130. The power storage unit 130 also stores the power from the SCL, and supplies the stored power to each communication device 30.

Accordingly, in the communication system 110 that performs I2C communication, each communication device 30 can operate using the power supplied from the power storage unit 130 as a power supply. Thus, provision of a power line from VDD to each communication device 30 can be omitted.

Further, as the provision of the power line from VDD to each communication device 30 is omitted, the number of wiring lines to be extended together with the I2C bus can be reduced, and the costs of the wiring lines can be lowered.

Furthermore, as the number of wiring lines is reduced, the cable that bundles the wiring lines extended together with the I2C bus can be prevented from becoming thicker. As a result, the weight of the cable is reduced, and the communication system that performs I2C communication can be reduced in weight.

Further, in a case where the communication device 20 as the master and the communication devices 30 as the slaves are not disposed on the same printed circuit board, but the communication device 20 and each communication device 30 are separated by a physical distance, the number of wiring lines to be extended with the I2C bus becomes smaller, and thus, the degree of freedom of arrangement of the communication devices 30 as the slaves can be increased. For example, it is possible to increase the degree of freedom of attachment in a case where the communication system 110 is applied to a wearable device as described above.

Further, it is possible to form the communication system 110 shown in FIG. 2 by adding the control circuit 120 and the power storage unit 130 to the conventional communication system 10 shown in FIG. 1. Thus, the communication system 110 can be easily formed using the conventional communication system 10.

The communication system 110 is capable of taking measures in cases where the power storage unit 130 does not store sufficient power, or where the power to be supplied from the power storage unit 130 to each communication device 30 is insufficient.

As described above with reference to FIG. 2, in a case where a normally-on switch is adopted as the switch 121, the power of the power storage unit 130 to be supplied to the communication devices 30 and the control circuit 120 is insufficient, and, when each communication device 30 and the control unit 122 of the control circuit 120 become inoperable, the normally-on switch 121 is turned on, to connect the power storage unit 130 and the SCL. As the power storage unit 130 and the SCL are connected, the power supplied from the SCL is stored into the power storage unit 130, and the power is then supplied as a power supply to each communication device 30 and the control circuit 120. As a result, the communication devices 30 and the control circuit 120 can return to an operable state.

Further, in a case where the communication device 20 and each communication device 30 are communicating with each other, if the power to be supplied from the power storage unit 130 to each communication device 30 and the control circuit 120 is likely to become insufficient, the control unit 122 performs control to forcibly turn on the switch 121 (FIG. 2) in accordance with the shortage (or the likelihood of a shortage) of the power. By doing so, the control unit 122 manages to store the power supplied from the SCL into the power storage unit 130, and thus, copes with the shortage of the power.

To cope with the power shortage, the communication device 20 may include a timer or the like, for example, to obtain a mechanism for adjusting the pace to the waiting time for charging (power storage) of the power storage unit 130. As such a mechanism is installed in the communication device 20, when the power to be supplied from the power storage unit 130 to the communication devices 30 and the control circuit 120 is insufficient in a case where the communication device 20 and the communication devices 30 are communicating, the communication device 20 waits only for the time necessary for charging the power storage unit 130, and can resume the communication after the charging necessary for the power storage unit 130 is completed.

Note that, to start waiting for the period of time necessary for charging the power storage unit 130 in this case, the communication device 20 needs to detect a shortage (or a likelihood of a shortage) of the power being supplied from the power storage unit 130 to the communication devices 30 and the control circuit 120.

In a case where the power being supplied from the power storage unit 130 to the communication devices 30 is insufficient, the communication devices 30 fail to perform communication properly, and become incapable of returning an acknowledge (Ack) signal compliant with the I2C standards to the communication device 20. Since any Ack signal is not returned from the communication devices 30, the communication device 20 detects that the power being supplied to the communication devices 30 is insufficient, and the communication devices 30 are incapable of performing communication properly.

Note that, in the communication device 20, the mechanism for adjusting the pace to the waiting time for charging of the power storage unit 130 can be realized by control performed by the software installed in the communication device 20.

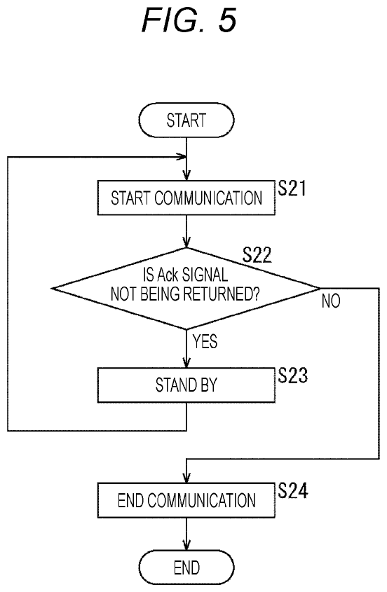

FIG. 5 is a flowchart for explaining an example process to be performed by the communication device 20 to cope with a shortage of the power to be supplied to the communication devices 30.

In step S21, the communication device 20 controls the switches 23 and 24 so that the states of the SCL and the SDA are switched to the starting conditions. By doing so, the communication device 20 declares the start of communication, and starts the communication. The process then moves from step S21 on to step S22.

In step S22, the communication device 20 determines whether an Ack signal is not being returned from the communication devices 30. In a case where the communication device 20 determines that any Ack signal is not being returned, or in a case where the communication devices 30 are unable to return any Ack signal due to a power shortage, the process moves on to step S23.

In step S23, the communication device 20 waits for a predetermined time, and the process returns to step S21.

In a case where the communication device 20 determines in step S22 that an Ack signal has been returned from the communication devices 30, the necessary data is exchanged between the communication device 20 and the communication devices 30, and the process then moves on to step S24.

In step S24, the communication device 20 controls the switches 23 and 24 so that the states of the SCL and the SDA are switched to the stopping conditions. By doing so, the communication device 20 declares the end of the communication, and ends the communication.

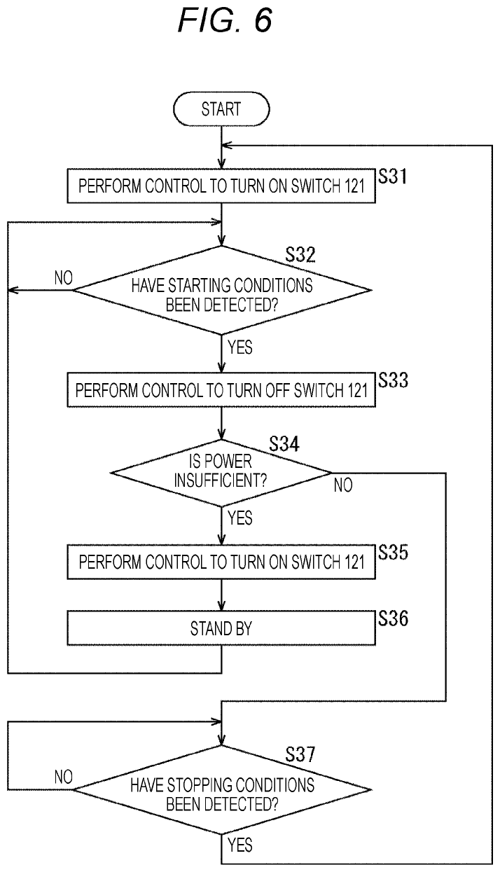

FIG. 6 is a flowchart for explaining an example process to be performed by the control circuit 120 to cope with a shortage of the power to be supplied to the communication devices 30.

In step S31, the control unit 122 performs control so that the switch 121 is turned on, and the process moves on to step S32. As the switch 121 is turned on, the power storage unit 130 is electrically charged with the electric power supplied from the SCL via the switch 121. The power stored in the power storage unit 130 is supplied as a power supply to the communication devices 30 (and the control circuit 120).

Note that, if the power stored in the power storage unit 130 is already insufficient in step S31, the normally-on switch 121 is turned on, regardless of the control of the control unit 122, and thus, the power storage unit 130 is electrically charged.

In step S32, the control unit 122 determines (detects) whether the states of the two buses of the SCL and the SDA have switched to the starting conditions. In a case where it is determined in step S32 that the states of the SCL and the SDA have not been switched to the starting conditions, the process returns to step S32. In a case where it is determined in step S32 that the states of the SCL and the SDA have switched to the starting conditions, on the other hand, the process moves on to step S33.

In step S33, the control unit 122 performs control so that the switch 121 is turned off, and the process moves on to step S34. As the switch 121 is turned off, the charging of the power storage unit 130 ends (is suspended). Even after the charging of the power storage unit 130 is completed, the power stored in the power storage unit 130 is supplied as a power supply to each communication device 30 (and the control circuit 120).

In step S34, on the basis of the voltage of the power storage unit 130, for example, the control unit 122 determines whether the power being supplied from the power storage unit 130 to the communication devices 30 is insufficient. In a case where the power is determined to be insufficient in step S34, the process moves on to step S35.

In step S35, the control unit 122 performs control so that the switch 121 is turned on, and the process moves on to step S36. As the switch 121 is turned on, power is supplied from the SCL to the power storage unit 130 via the switch 121, and the power storage unit 130 is electrically charged with the power.

In step S36, the control unit 122 waits until the electric power required for the power storage unit 130 is stored. After that, the process returns from step S36 to step S32, and processes similar to the above are then repeated.

In a case where the power is determined not to be insufficient in step S34, on the other hand, the process moves on to step S37.

In step S37, the control unit 122 determines (detects) whether the states of the two buses of the SCL and the SDA have switched to the stopping conditions. In a case where it is determined in step S37 that the states of the SCL and the SDA have not switched to the stopping conditions, the process returns to step S37. In a case where it is determined in step S37 that the states of the SCL and the SDA have switched to the stopping conditions, on the other hand, the process returns to step S31, and the control unit 122 performs control so that the switch 121 is turned on, as described above.

After that, processes similar to the above are repeated, so that control is performed to turn on or off the switch 121, depending on the states of the two buses of the SCL and the SDA.

As described above, when the power to be supplied from the power storage unit 130 to the communication devices 30 is insufficient, the control unit 122 performs control to forcibly turn on the switch 121 in response to the shortage of the power. By doing so, the control unit 122 manages to store the power supplied from the SCL into the power storage unit 130, and thus, copes with the power shortage.

The communication device 20 also waits until the power storage unit 130 is filled (charged) with power, and resumes communication after the power storage (charging).

Thus, it is possible to avoid a deadlock in which the power being supplied from the power storage unit 130 to the communication devices 30 becomes insufficient while communication is being performed between the communication device 20 and the communication devices 30, and the communication device 20 continues to wait for an Ack signal from the communication devices 30 that are in an inoperable state.

### Second Embodiment

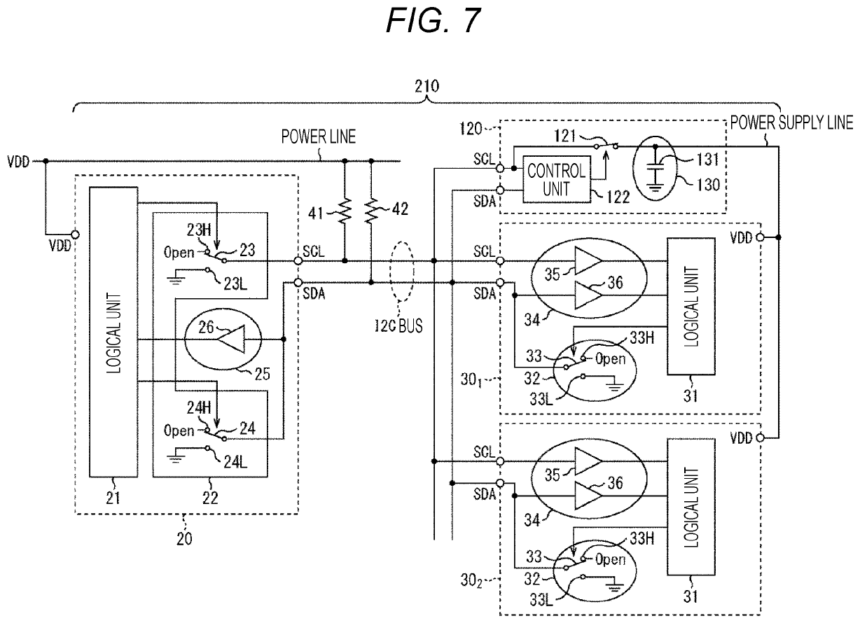

FIG. 7 is a block diagram showing an example configuration of a second embodiment of a communication system to which the present technology is applied.

Note that, in the drawing, the components corresponding to those in FIG. 2 are denoted by the same reference numerals as those used in FIG. 2, and explanation of them is not repeated herein.

Although the power storage unit 130 is not included in the control circuit 120 in the communication system 110 shown in FIG. 2, the power storage unit 130 is included in the control circuit 120 in a communication system 210 shown in FIG. 7. The communication system 210 has a configuration similar to that of the communication system 110, except that the power storage unit 130 is included in the control circuit 120 as described above.

As described above, the power storage unit 130 may be disposed outside the control circuit 120, or may be disposed in the control circuit 120.

### Third Embodiment

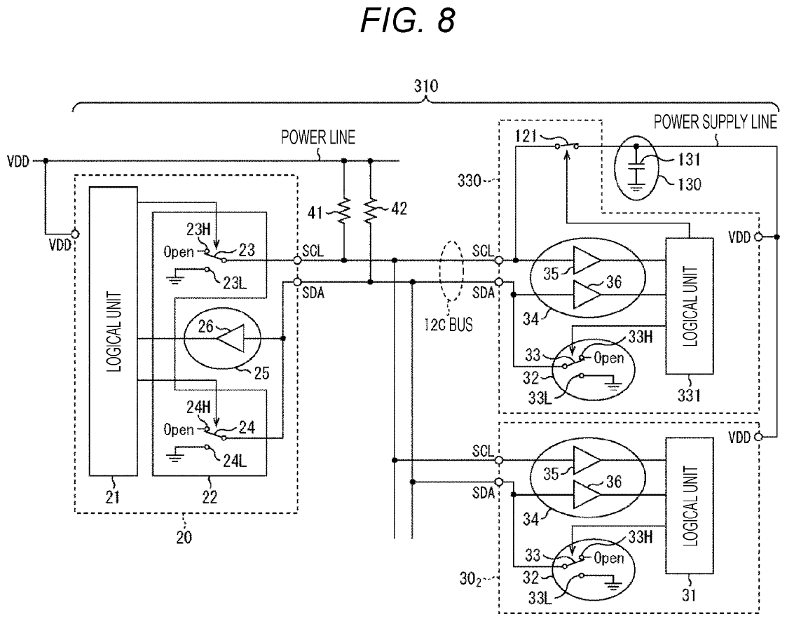

FIG. 8 is a block diagram showing an example configuration of a third embodiment of a communication system to which the present technology is applied.

Note that, in the drawing, the components corresponding to those in FIG. 2 are denoted by the same reference numerals as those used in FIG. 2, and explanation of them is not repeated herein.

In FIG. 8, a communication system 310 includes a communication device 20, a communication device 30₂, a communication device 330, and a power storage unit 130.

Accordingly, the communication system 310 is the same as the communication system 110 shown in FIG. 2, in including the communication device 20, the communication device 30₂, and the power storage unit 130.

However, in not including the control circuit 120, the communication system 310 differs from the communication system 110 that includes the control circuit 120. The communication system 310 further differs from the communication system 110, in including the communication device 330, instead of the communication device 30₁.

The communication device 330 is a communication device that functions as an I2C slave.

The communication device 330 includes a transmission unit 32, a reception unit 34, a switch 121, and a logical unit 331.

Accordingly, the communication device 330 is the same as the communication device 30₁ shown in FIG. 2, in including the transmission unit 32 and the reception unit 34.

However, the communication device 330 differs from the communication device 30₁, in that the logical unit 331 is provided in place of the logical unit 31, and the switch 121 is added.

The logical unit 331 performs processes similar to those to be performed by the control unit 122, in addition to the processes to be performed by the logical unit 31. Accordingly, like the control unit 122, the logical unit 331 performs control to turn on or off the switch 121, depending on the states of the two buses of the SCL and the SDA.

In the communication system 310 configured as described above, the communication device 330 functions as the communication device 30₁, and also functions as the control circuit 120 shown in FIG. 2. Accordingly, with the communication system 310, it is possible to achieve effects similar to those of the communication system 110 shown in FIG. 2.

### Fourth Embodiment

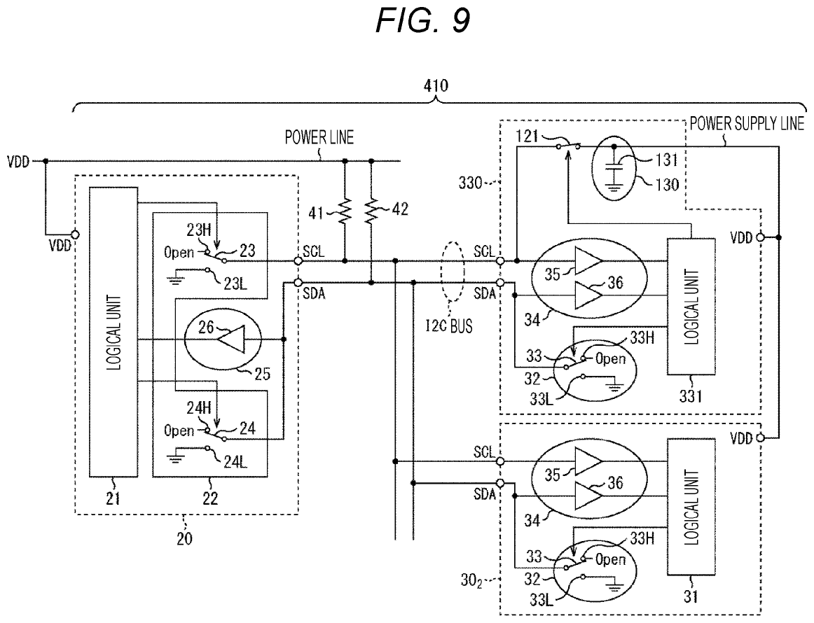

FIG. 9 is a block diagram showing an example configuration of a fourth embodiment of a communication system to which the present technology is applied.

Note that, in the drawing, the components corresponding to those in FIG. 8 are denoted by the same reference numerals as those used in FIG. 8, and explanation of them is not repeated herein.

Although the power storage unit 130 is not included in the communication device 330 in the communication system 310 shown in FIG. 8, the power storage unit 130 is included in the communication device 330 in a communication system 410 shown in FIG. 9. The communication system 410 has a configuration similar to that of the communication system 310, except that the power storage unit 130 is included in the communication device 330 as described above.

As described above, the power storage unit 130 may be disposed outside the communication device 330, or may be disposed in the communication device 330.

Here, the communication device 20 as the master is mainly applied to a microcomputer (a microcontroller), and readily replacing or redesigning the communication device 20 in the system is highly likely to be difficult.

On the other hand, each communication device 30 is a communication device to which a device such as a sensor is connected, and is selected (the specifications are changed) in accordance with the purpose of use of the system, for example.

It is possible to form the communication system 410 in FIG. 9 simply by changing the specifications of a communication device 30, without any change in the specifications of the communication device 20 of the communication system 10 shown in FIG. 1.

It is possible to form the communication system 110 in FIG. 2 simply by using the communication device 20 and the communication devices 30₁ and 30₂ in FIG. 1 without any change, and adding the control circuit 120 and the power storage unit 130 thereto.

It is also possible to form the communication system 210 in FIG. 7 simply by using the communication device 20 and the communication devices 30₁ and 30₂ in FIG. 1 without any change, and adding the control circuit 120 including the power storage unit 130 thereto.

Accordingly, as for the communication system 110 shown in FIG. 2 and the communication system 210 shown in FIG. 7, the communication device 20 and the communication devices 30₁ and 30₂ of the conventional communication system 10 performing I2C communication can be used without any change. Thus, redesigning the entire communication system, which is redesigning the communication device 20 as the master and the communication devices 30 as the slaves, becomes unnecessary.

It is possible to form the communication system 310 in FIG. 8 simply by using the communication device 20 and the communication device 30₂ in FIG. 1 without any change, and adding the power storage unit 130 and the communication device 330 thereto.

It is also possible to form the communication system 410 in FIG. 9 simply by using the communication device 20 and the communication device 30₂ in FIG. 1 without any change, and adding the communication device 330 including the power storage unit 130 thereto.

Accordingly, as for the communication system 310 shown in FIG. 8 and the communication system 410 shown in FIG. 9, the communication device 20 and the communication device 30₂ of the conventional communication system 10 performing I2C communication can be used without any change. Thus, redesigning the entire communication system, which is redesigning the communication device 20 as the master and the communication device 30₂ as a slave, becomes unnecessary.

Further, while each communication device 30 is a conventional I2C slave, the communication device 330 in FIG. 8 (and the communication device 330 in FIG. 9) can be regarded as a novel slave that has a function of performing control to store electric power and supply the power as a power supply, in addition to the functions of a conventional I2C slave. Even in a case where the communication device 330 as a novel slave is added to the communication system 10 including the communication devices 30 as conventional I2C slaves in FIG. 1, the communication device 330 does not compete with the communication devices 30 as the conventional I2C slaves, and no problems occur between the communication device 20 and the communication devices 30. Accordingly, the communication device 330 as a novel slave can be easily added to the communication system 10 including the communication devices 30 as conventional I2C slaves.

Note that, in this embodiment, an I2C bus is adopted as a plurality of buses connecting the communication device 20 as the master to the communication devices 30 as slaves and the communication device 330 as a new slave. However, instead of an I2C bus, any appropriate two or more buses including at least one pulled-up bus can be adopted as the plurality of buses.

<Description of a Computer to which the Present Technology is Applied>

Next, the series of processes performed by the control unit 122 and the logical unit 331 described above can be performed with hardware, and can be performed with software. In a case where the series of processes is performed with software, the program that forms the software is installed into a computer.

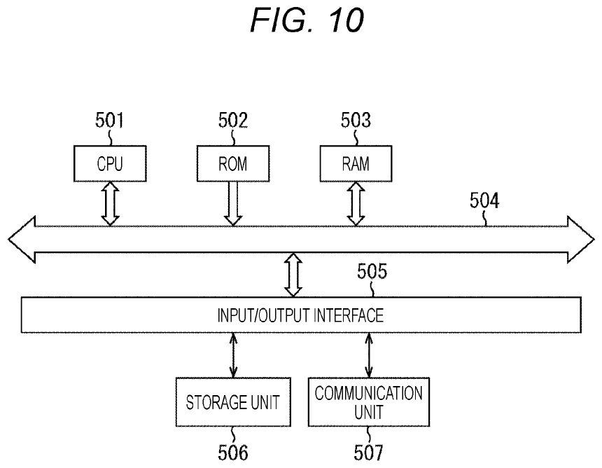

In view of this, FIG. 10 shows an example configuration of an embodiment of a computer into which the program for performing the series of processes described above is installed.

In FIG. 10, a central processing unit (CPU) 501 performs various kinds of processes in accordance with a program stored in a read only memory (ROM) 502, or a program loaded from a storage unit 506 into a random access memory (RAM) 503. The RAM 503 also stores data necessary for the CPU 501 to perform various processes and the like as appropriate.

The CPU 501, the ROM 502, and the RAM 503 are connected to one another via a bus 504. An input/output interface 505 is also connected to the bus 504.

The storage unit 506 formed with a hard disk or the like, and a communication unit 507 formed with a communication interface are connected to the input/output interface 505. The communication unit 507 performs communication processes via a network such as the Internet, for example.

The computer program can be received by the communication unit 507 via a wired or wireless transmission medium, and be installed into the storage unit 506 via the input/output interface 505. Alternatively, the program may be installed beforehand into the ROM 502 or the storage unit 506.

Note that the program to be executed by the computer may be a program for performing processes in chronological order in accordance with the sequence described in this specification, or may be a program for performing processes in parallel or performing a process when necessary, such as when there is a call.

Embodiments of the present technology are not limited to the embodiments described above, and various modifications may be made to them without departing from the scope of the present technology.

Note that the advantageous effects described in this specification are merely examples, and the advantageous effects of the present technology are not limited to them and may include effects other than those described in this specification.

<Other Aspects>

The present technology may also be embodied in the configurations described below.

(1)

A control circuit including:

a switch that switches on or off connection between a pulled-up bus and a power storage unit, the pulled-up bus being a bus that is pulled up in a plurality of buses that are connected to a communication device and include at least one bus that is pulled up, the power storage unit storing electric power supplied from the pulled-up bus and supplying the stored electric power as a power supply to the communication device; and

a control unit that performs control to turn on or off the switch.

(2)

The control circuit according to (1), further including

the power storage unit.

(3)

The control circuit according to (1) or (2), in which

the power storage unit is a capacitor.

(4)

The control circuit according to any one of (1) to (3), in which

the control unit performs control to turn on or off the switch, depending on states of the buses.

(5)

The control circuit according to (4), in which

the control unit performs control to turn off the switch, as the states of the buses become states to start communication.

(6)

The control circuit according to (4) or (5), in which

the control unit performs control to turn on the switch, as the states of the buses become states to end communication.

(7)

The control circuit according to any one of (1) to (5), in which

the control unit performs control to turn on the switch, as electric power being supplied from the power storage unit to the communication device is insufficient.

(8)

The control circuit according to any one of (1) to (7), in which

the switch is a normally-on switch.

(9)

The control circuit according to any one of (1) to (8), in which

the plurality of buses is inter-integrated circuit (I2C) buses, and

the pulled-up bus is a serial clock line (SCL).

(10)

A communication device including:

a switch that switches on or off connection between a pulled-up bus and a power storage unit, the pulled-up bus being a bus that is pulled up in a plurality of buses that are connected to the communication device and include at least one bus that is pulled up, the power storage unit storing electric power supplied from the pulled-up bus and supplying the stored electric power as a power supply to the communication device; and

a logical unit that performs control to turn on or off the switch.

(11)

A communication system including:

a first communication device and a second communication device that are connected to a plurality of buses having at least one bus pulled up, and perform communication via the plurality of buses;

a power storage unit that stores electric power supplied from a pulled-up bus that is a bus pulled up in the plurality of buses, and supplies the stored electric power as a power supply to the second communication device; and

a control circuit that controls connection between the pulled-up bus and the power storage unit,

in which the control circuit includes:

a switch that switches on or off connection between the pulled-up bus and the power storage unit; and

a control unit that performs control to turn on or off the switch.

(12)

A communication system including:

a first communication device and a second communication device that are connected to a plurality of buses having at least one bus pulled up, and perform communication via the plurality of buses; and

a power storage unit that stores electric power supplied from a pulled-up bus that is a bus pulled up in the plurality of buses, and supplies the stored electric power as a power supply to the second communication device,

in which the second communication device includes:

a switch that switches on or off connection between the pulled-up bus and the power storage unit; and

a logical unit that performs control to turn on or off the switch.

### REFERENCE SIGNS LIST

10 Communication system
20 Communication device
21 Logical unit
22 Transmission unit
23 Switch
23H, 23L Terminal
24 Switch
24H, 24L Terminal
25 Reception unit
26 Buffer
30 Communication device
31 Logical unit
32 Transmission unit
33 Switch
33H, 33L Terminal
34 Reception unit
35, 36 Buffer
41, 42 Pull-up resistor
110 Communication system
120 Control circuit
121 Switch
122 Control unit
130 Power storage unit
131 Capacitor
210, 310 Communication system
330 Communication device
331 Logical unit
410 Communication system
501 CPU
502 ROM
503 RAM
504 Bus
505 Input/output interface
506 Storage unit
507 Communication unit

1. A control circuit comprising:
a switch that switches on or off connection between a pulled-up bus and a power storage unit, the pulled-up bus being a bus that is pulled up in a plurality of buses that are connected to a communication device and include at least one bus that is pulled up, the power storage unit storing electric power supplied from the pulled-up bus and supplying the stored electric power as a power supply to the communication device; and
a control unit that performs control to turn on or off the switch.

2. The control circuit according to claim 1, further comprising
the power storage unit.

3. The control circuit according to claim 2, wherein
the power storage unit is a capacitor.

4. The control circuit according to claim 1, wherein
the control unit performs control to turn on or off the switch, depending on states of the buses.

5. The control circuit according to claim 4, wherein
the control unit performs control to turn off the switch, as the states of the buses become states to start communication.

6. The control circuit according to claim 4, wherein
the control unit performs control to turn on the switch, as the states of the buses become states to end communication.

7. The control circuit according to claim 1, wherein
the control unit performs control to turn on the switch, as electric power being supplied from the power storage unit to the communication device is insufficient.

8. The control circuit according to claim 1, wherein
the switch is a normally-on switch.

9. The control circuit according to claim 1, wherein
the plurality of buses is inter-integrated circuit (I2C) buses, and
the pulled-up bus is a serial clock line (SCL).

10. A communication device comprising:
a switch that switches on or off connection between a pulled-up bus and a power storage unit, the pulled-up bus being a bus that is pulled up in a plurality of buses that are connected to the communication device and include at least one bus that is pulled up, the power storage unit storing electric power supplied from the pulled-up bus and supplying the stored electric power as a power supply to the communication device; and
a logical unit that performs control to turn on or off the switch.

11. A communication system comprising:
a first communication device and a second communication device that are connected to a plurality of buses having at least one bus pulled up, and perform communication via the plurality of buses;
a power storage unit that stores electric power supplied from a pulled-up bus that is a bus pulled up in the plurality of buses, and supplies the stored electric power as a power supply to the second communication device; and
a control circuit that controls connection between the pulled-up bus and the power storage unit,
wherein the control circuit includes:
a switch that switches on or off connection between the pulled-up bus and the power storage unit; and
a control unit that performs control to turn on or off the switch.

12. A communication system comprising:
a first communication device and a second communication device that are connected to a plurality of buses having at least one bus pulled up, and perform communication via the plurality of buses; and
a power storage unit that stores electric power supplied from a pulled-up bus that is a bus pulled up in the plurality of buses, and supplies the stored electric power as a power supply to the second communication device,
wherein the second communication device includes:
a switch that switches on or off connection between the pulled-up bus and the power storage unit; and
a logical unit that performs control to turn on or off the switch.
